(19) United States
(12) Patent Application Publication
(10) Pub. No.: US 2025/0260196 A1
(43) Pub. Date: Aug. 14, 2025

(54) ELECTRICAL CONNECTORS WITH ARC PROTECTION

(71) Applicant: IDEAL Industries, Inc., Sycamore, MA (US)

(72) Inventors: Christine Svelnis, Boylston, MA (US); Richard Griffith, Rindge, NH (US)

(21) Appl. No.: 18/854,860

(22) PCT Filed: Apr. 11, 2022
(86) PCT No.: PCT/US2022/024251

§ 371 Date: Oct. 7, 2024

(51) Int. Cl. H01R 13/53; H01R 4/18; H01R 13/15

(52) U.S. Cl. CPC H01R 13/53; H01R 13/15; H01R 4/184

(57) ABSTRACT

An example electrical contact includes a primary contact portion configured to contact a mating electrical contact to form an electrical connection: and two or more protrusions extending from a forward portion of the electrical contact that is forward of the primary contact portion along a longitudinal disconnect direction, wherein the two or more protrusions are configured to receive external arcing from the mating electrical contact during a disconnect event.

### TECHNICAL FIELD

This disclosure generally relates to electrical connectors, including electrical connectors that withstand repeated electrical arcing.

### BACKGROUND

When an electrical connection is disconnected or unplugged, the electricity previously passing across the connection may arc across the newly-formed gap between connectors.

### BRIEF DESCRIPTION OF THE DRAWINGS

FIG. 1A is a side view of an example electrical connector assembly in a first state.

FIG. 1B is a side view of an example electrical connector assembly in a second state.

FIG. 2 is a perspective view of an example connector receptacle.

FIG. 3 is a perspective view of an example connector plug.

FIG. 4 is a perspective view of an example electrical connector contact.

FIG. 5 is a front view of an example electrical connector contact.

FIG. 6 is a rear view of an example electrical connector contact.

FIG. 7 is a top view of an example electrical connector contact.

FIG. 8 is a bottom view of an example electrical connector contact.

FIG. 9 is a side view of an example electrical connector contact.

FIG. 10 is a perspective view of an example electrical connector contact.

FIG. 11 is a flow chart illustrating an example method of utilizing the example electrical connector assembly of FIGS. 1A-B.

### DETAILED DESCRIPTION

When two electrical contacts that had been conducting current separate from each other, the electrical current may arc from one contact the other. Arcing may raise the temperature of the contacts to a degree that degrades or even removes material from one or both contacts. A novel electrical connector according to the present disclosure may provide a degree of protection against performance degradation resulting from arcing damage through a sacrificial feature that may be part of the contact but separate from the primary connection point and/or otherwise not required for quality conduction. This feature may bear the brunt of the damage caused by arcing instead of the primary connection point. In particular, the electrical connector may include one or more protrusions, such as horns, that may extend beyond the primary connection point, such that the protrusion touches the mating electrical contact after the primary connection point has stopped touching during disconnect. Any arcing from the mating electrical contact may be absorbed by the protrusion rather than the primary connection point, protecting the primary connection point.

Arcing is more likely to occur in high-power applications. Accordingly, a connector based on the present disclosure may find particular use in high-power applications. For example, in some embodiments, a connector may find use in power transmission of 12,000 watts or more. In some embodiments, a connector according to the present disclosure may find use in power transmission of 16,000 watts or more.

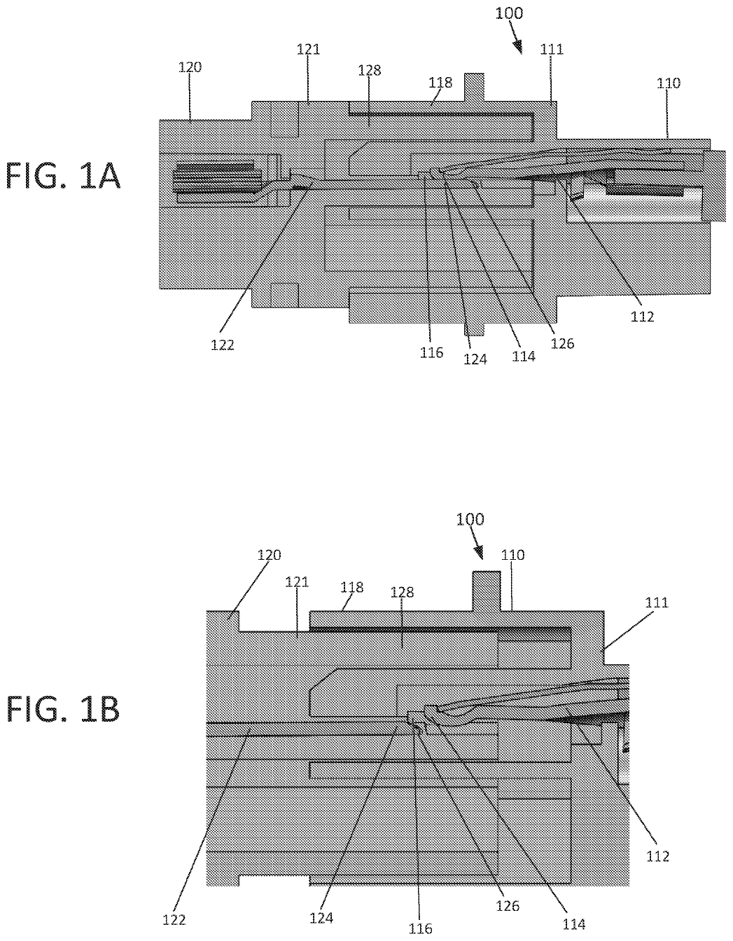

Referring now to the drawings, wherein like numerals refer to the same or similar features in the various views, FIGS. 1A-B illustrate an example electrical connector assembly 100 in two stages of connection. FIG. 1A illustrates a fully-connected state, and FIG. 1B illustrates a state immediately before complete physical disconnect of the contacts of the connector assembly. The connector assembly 100 may include a first connector 110 and a second connector 120. The first connector 110 may include a first electrical contact 112, which includes a primary contact portion 114 and a protrusion 116 (e.g., a horn), and a housing 111 that defines one or more apertures 117. The first connector 110 may further be configured as a receptacle (e.g., configured to receive the second connector 120), and may include a first outer portion 118 having a relatively larger inner width than a second outer portion 128 of the second connector 120. The connector assembly 100 may be formed by mating the first connector 110 with the second connector 120 (e.g., as shown in FIG. 1A) by fitting the first outer portion 118 of the first connector 110 around the second outer portion 128 of the second connector 120. The second connector 120 may include a second electrical contact 122, which may include a mating contact portion 124, and a housing 121 that defines one or more apertures 127.

FIG. 1A illustrates the electrical connector assembly 100 in a complete coupling in which the primary contact portion 114 is touching the mating contact portion 124. In this arrangement, electrical current may be flowing along the connection formed by the primary contact portion 114 and the mating contact portion 124 (e.g., from the first connector 110 to the second connector 120). FIG. 1B illustrates the electrical connector assembly 100 in a partially decoupled (or disconnected) state in which the primary contact portion 114 is not touching the mating contact portion 124 but the first outer portion 118 is in contact (e.g., around) the second outer portion 128. In the partially decoupled state, the mating contact portion 124 may be touching only the protrusion 116. As such, when the electrical connector assembly 100 may be completely decoupled (e.g., the second connector 120 is completely removed from within the first connector 110), the last point of contact with the second electrical contact 122 may be the protrusion 116. Because, as described above, electrical current may arc from the second electrical contact 122 to the last point of contact as the electrical connector assembly 100 is decoupled, electrical current may arc to the protrusion 116 rather than to the primary contact portion 114.

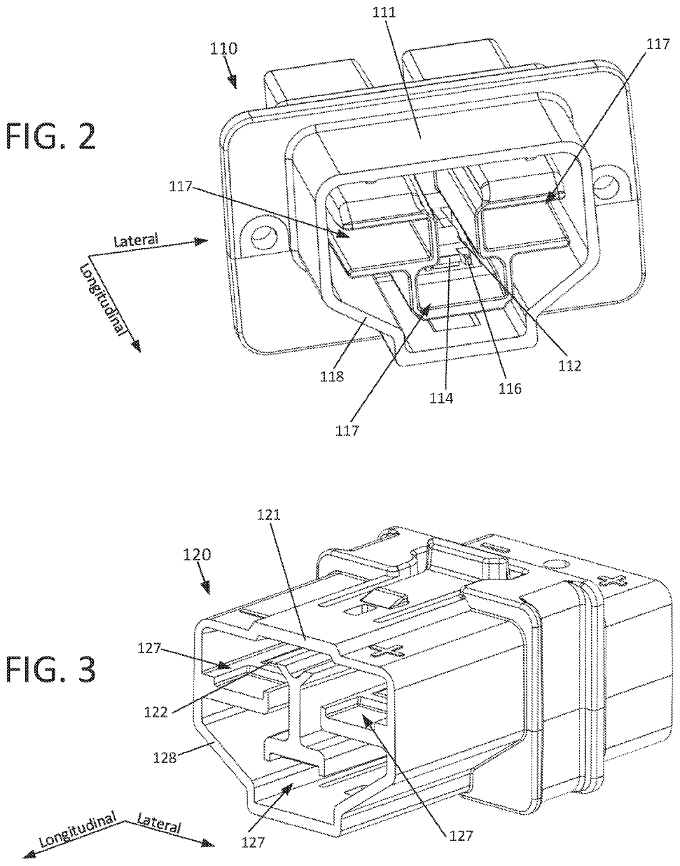

Referring to FIG. 2, the housing 111 of the first connector 110 includes three apertures 117, each of which may contain a respective first electrical contact 112 (e.g., a respective first contact 112 may be accessible through each aperture 117). The contacts 112 may be identical to each other (e.g., having the same dimensions and components) and may be in identical orientations, in some embodiments. In other embodiments, the contacts 112 may be different from each other and/or may be in different orientations from each other. The housing 111 may include a glass-filled material to improve the overall arcing resistance of the first connector 110 as glass fibers resist burning across repeated arcings.

Referring to FIG. 3, the housing 121 of the second connector 120 includes three apertures 127, each of which may contain a respective second electrical contact 122 (e.g., a respective second contact 122 may be accessible through each aperture 127). The contacts 122 may be identical to each other (e.g., having the same dimensions and components) and may be in identical orientations, in some embodiments. In other embodiments, the contacts 122 may be different from each other and/or may be in different orientations from each other. Each of the apertures 127 may correspond to a respective aperture 117, such that when the second connector 120 is inserted into the first connector 110, each aperture 127 mates with an aperture 117. The housing 121 may include a glass-filled material to improve the overall arcing resistance of the first connector 110 as glass fibers resist burning across repeated arcings.

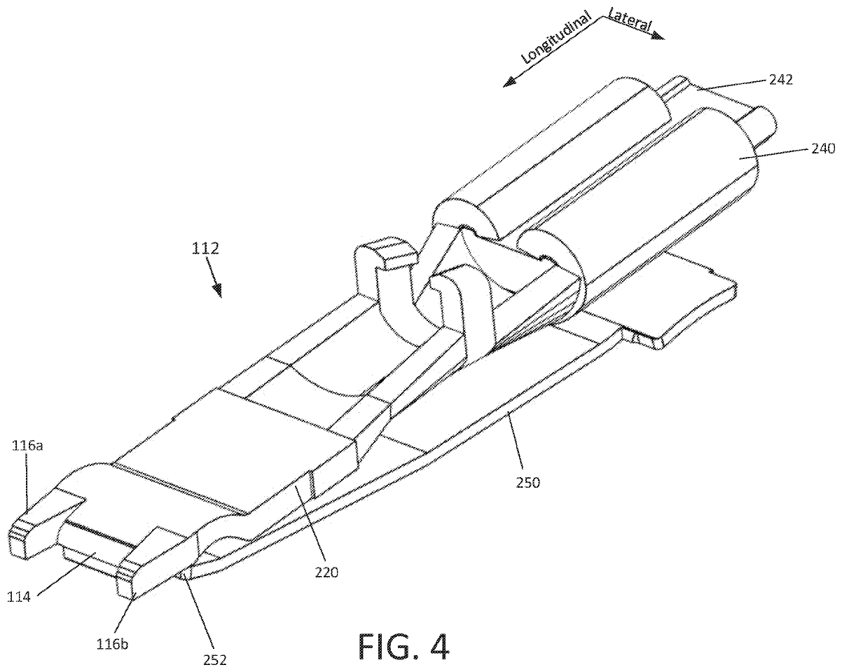

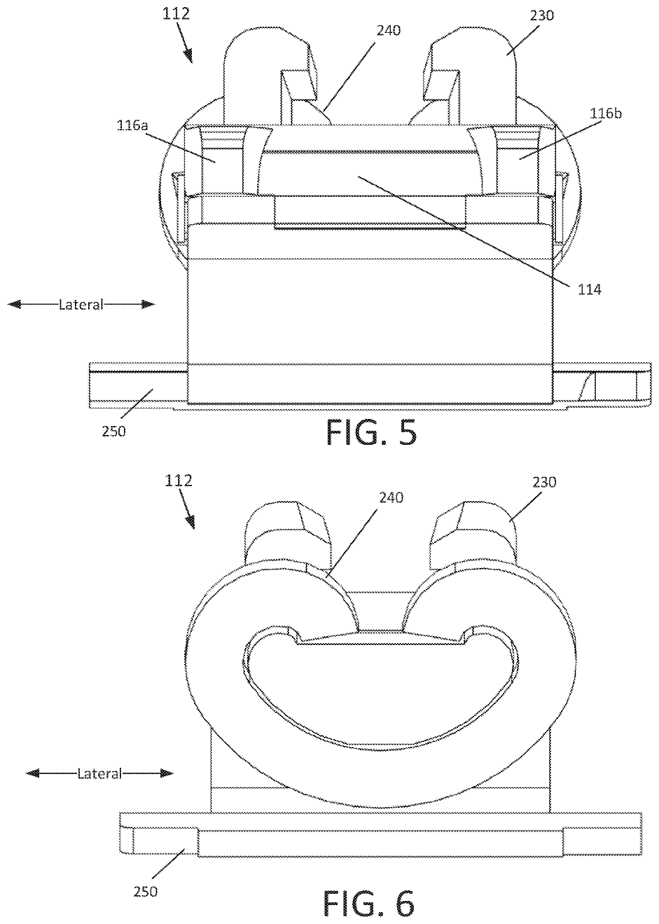

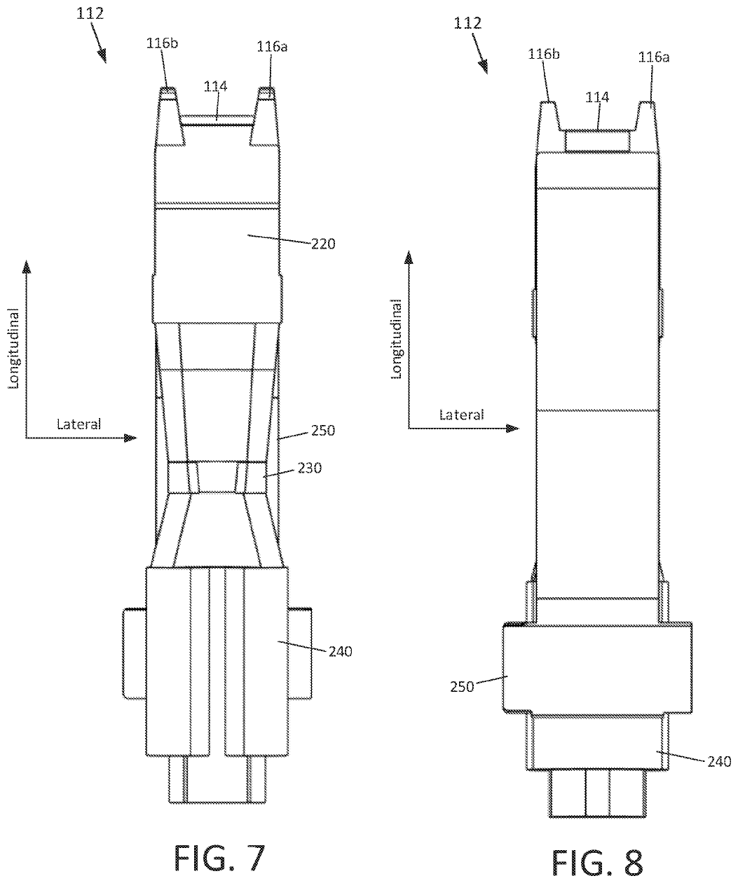

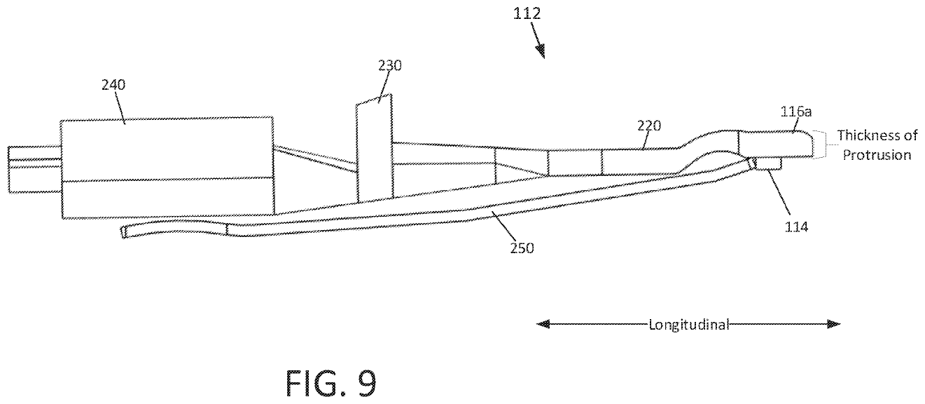

FIGS. 4-9 illustrate various views of an example of the electrical connector contact 112. The contact 112 may include a first protrusion 116a and a second protrusion 116b (which may be collectively referred to as “protrusions 116” or individually as a “protrusion 116”)), a primary contact portion 114, a wire surface 220, a wire stop 230, and a wire crimp 240. The protrusions 116 may be disposed on a forward portion of the contact 112 and extend longitudinally relative to the contact 112. In some embodiments, the protrusions 116 may be disposed on the forward-most portion of the contact 112. The protrusions 116 and the contact 112 may be formed from a monolithic body of material, such that the protrusions 116 are not separately formed and then attached (e.g., welded) to the contact 112. This may improve the manufacturing process, as the protrusions 116 may be formed by stamping a single sheet of material, rather than having to be separately manufacture and then welded or otherwise acted upon. Furthermore, because there are no welding joints or other seams between materials, the contact 112 may be more durable.

In some embodiments, such as the embodiment shown in FIG. 4, the first protrusion 116a and the second protrusion 116b may be disposed on laterally-opposed edges of the contact 112, such that the first protrusion 116a may extend from a right side of the forward portion of the contact 112 and the second protrusion 116b may extend from a left side of the forward portion of the contact 112, with a lateral gap in between. In other embodiments, the first protrusion 116a and the second protrusion 116b may be immediately next to each other, such that there is no gap between the first protrusion 116a and the second protrusion 116b. In further embodiments, the protrusions 116 may include a single protrusion, or may include three or more protrusions.

In those embodiments in which the contact 112 includes multiple protrusions 116, the protrusion receiving the arcing may change from one disconnect event to the next. Because the arcing travels to the point of contact last touching the mating contact and because the arcing may damage that last point of contact and removes some amount of material, the protrusion that receives the arcing may be made marginally shorter than the protrusion that did not receive the previous arcing. For example, if arcing from the mating contact goes to and damages the first protrusion 116a, the arcing from the mating contact on the next disconnect may be expected to travel to and damage the second protrusion 116b because the damage from the first arcing shortened the first protrusion 116a. In this manner, providing many protrusions enable arcing protection over many cycles without excessively-long protrusions.

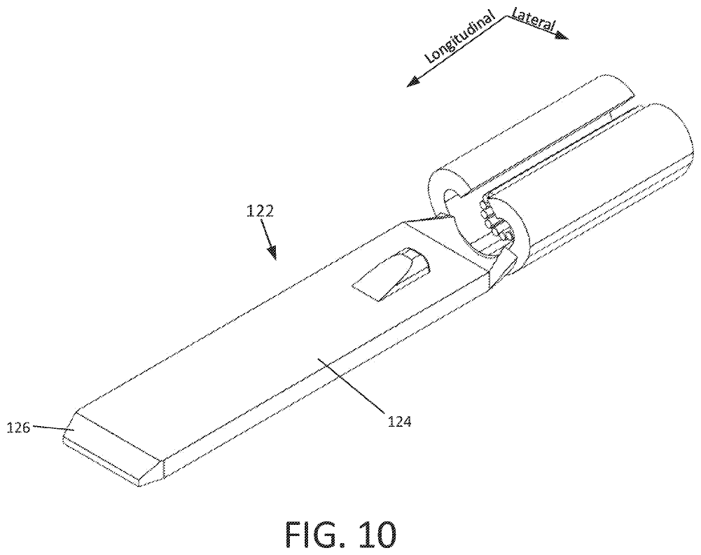

The primary contact portion 114 may be located laterally between and longitudinally rearward of the first protrusion 116a and the second protrusion 116b, and may be configured to form a consistent electrical connection with a contact portion of another connector (e.g., a plug connector). As such, the primary contact portion 114 may include an extended flat surface that may more effectively transfer current when flush with a corresponding contact portion of the other connector (e.g., mating contact tip 126 or mating contact portion 124 of the mating contact 122 shown in FIG. 10). As shown in FIG. 4, this extended flat surface may be the top (relative to the orientation of the view in FIG. 4) and may be further extended by inclusion of a curvature that transitions from a relative top of the contact 112 to a bottom. The contact 112 may further include a spring 250 to bias the contact portion 114 towards the mating contact portion 124. The spring 250 may interface with the contact 112 at spring bias point 252.

The protrusions 116 may have a flat top surface coplanar with the flat surface of the contact point that tapers as the protrusions 116 extend longitudinally and rounds into a flat front surface. The top surface of the protrusions 116 may be, from a top perspective, substantially triangular or otherwise wedge-shaped, with the point portion longitudinally disposed towards a relative front of the contact 112. Because the protrusions 116 may have a relatively small forward surface area (e.g., the tip of the triangle or wedge-shape), the protrusions 116 may be less likely to form a butt weld with the second contact 122 when first touching. Alternatively, the protrusions 116 may be rectangular or any other appropriate shape. Because the top surface of the protrusions 116 may be coplanar with a surface of the contact portion 114, the protrusions 116 may be similarly flush with the corresponding point of contact of the other connector when mated. This may enable the protrusions 116 to remain flush (or at least touching) the mating contact portion 124 or the mating contact tip 126 after the contact portion 114 is no longer touching the mating contact 122 (e.g., as the respective connectors are disengaged).

Furthermore, because the protrusions 116 may extend beyond the primary contact portion 114, the protrusions 116 may protect the primary contact portion 114 from physical wear during connect and disconnect events, in addition to the arc protection discussed above. When the first connector 110 and the second connector 120 are mated, the protrusions 116 are the first part of the first contact 112 to touch the second contact 122. As discussed above, the first contact 112 includes a spring 250 to bias the first contact 112 towards the second contact 122. Due to the spring 250 biasing the first contact 112 towards the second contact 122, when the first contact 112 and the second contact 122 first touch (e.g., during mating), the surfaces of each may not be initially flush and may instead be forced flush by the mating process. This force could damage and/or bend the primary contact portion 114, but by extending the protrusions 116 forward from the primary contact portion 114, the protrusions 116 may receive that damage instead of the primary contact portion 114, regardless of whether the connection is active (e.g., hot).

The amount by which the protrusions 116 extend may be measured from a point at which the contact portion 114 begins to taper (e.g., where the contact portion 114 starts) and may be selected according to one or more factors. In some embodiments, the amount of extension may be based on a thickness of the material, where the amount of extension is proportional (e.g., 1.5 times) to the material thickness. This proportion may depend on the type of material. For example, a stronger or more resilient material may support a longer extension relative to thickness. The amount of extension may further depend on one or more industry regulations. In one example, the amount of extension may be based on a minimum number of disconnects (e.g., 250 disconnects), where the amount of extension is greater than or equal to the amount of material expected to be lost to arcing across the minimum number of disconnects. As discussed above, the amount of material lost to arcing may be distributed evenly across the protrusions 116, so the amount of extension of each prong may be equal to half of the total amount of lost material. In another example, the amount of extension may be based on a IP20 (“Finger Safe”) safety rating, which requires that a probe approximately the size of a human finger, if inserted into an open end of a connector, not be able to touch any live or energized parts of the connector. In this example, the amount of the extension is long enough to extend beyond the contact portion 114 but short enough to remain within the safety ratings (e.g., cannot be touched by the finger probe).

As shown in FIG. 4, the wire surface 220 may be a flat portion of the contact 112 that extends longitudinally from the forward portion of the contact towards the rear portion. The wire surface 220 may be configured to receive one or more exposed ends of a wire(s) or cable(s) inserted into the connector that is housing the contact 112 to expand the conductivity of the wire to the entire contact 112. The wire stop 230 may include one or more hook-shaped protrusions that extend perpendicularly from a surface of the contact 112 and that are positioned to the rear of the wire surface 220. The wire stop 230 may be configured to prevent the unexposed portions of the wire(s) that are inserted into the rear of the contact 112 from moving too far along the contact 112, such that the exposed end of the wire may be on the wire surface 220 not the contact portion 114 or protrusions 116. The wire crimp 240 may include one or more wing-shaped protrusions that extend outward from the surface of the contact 112 and are configured to move radially inward relative to an inserted wire to bind or otherwise hold the wire in place. In the embodiment shown in FIG. 4, the wire crimp 240 has been moved radially inward and is in a crimped position over a wire portion 242. As such, the wire crimp 240 may be thinner than other portions of the contact 112 to be malleable in response to pressure. In some embodiments, the pressure may be applied to an over-mold of the connector that is housing the contact 112, which may then be transferred to the wire crimp 240. In one example, a user may insert a wire into the connector until the unexposed portions of the wire abut the wire stop 230, and subsequently squeeze the connector, which may cause the wing-shaped protrusions of the wire crimp 240 to move radially inward and secure the wire in place. In this position, the exposed ends of the wire are touching the wire surface 220, energizing the entire contact 112.

FIG. 10 illustrates an example mating contact 122. In some embodiments, the mating contact 122 may be included in a plug connector and be analogous to the second electrical contact 122 of FIGS. 1A-B. The mating contact 122 may be complementary to the contact 112, such that the contact 112 and mating contact 122 may combine or mate to form an electrical connection. Although the contact 112 and mating contact 122 are described herein as being included in the receptacle and plug connectors respectively, the opposite may be true as long as one connector houses the contact 112 and the other connector houses the mating contact 122.

In some embodiments, the contact 112 may be included in a receptacle connector. Because a receptacle connector may be more difficult to replace than a plug connector and/or may experience more disconnect events than a plug connector (e.g., multiple machines utilizing a single outlet), including sacrificial protrusions on a contact in the receptacle may be preferred over including sacrificial protrusions on a contact in the plug. In some embodiments, however, sacrificial protrusions may be included on a contact in the plug in addition to or instead of the sacrificial protrusions on the receptacle contact.

As shown in FIG. 10, the mating contact 122 may include a mating contact tip 126 and a mating contact portion 124. The mating contact tip 126 may be chamfered to facilitate a smoother connection with the contact 112, as the slope of the chamfer may allow the contact portion 114 to more smoothly slide into a flush position with the mating contact portion 124. Due to the additional stress on the mating contact tip 126 from this sliding, the mating contact tip 126 may be composed of a different material (e.g., stainless steel) than the other portions of the mating contact 122. In other embodiments, the mating contact tip 126 may be continuous with the other portions of the mating contact 122, such that the mating contact tip 126 may not include the chamfer and may not be composed of a different material. The mating contact portion 124 may be a relatively flat surface that may extend longitudinally from the mating contact tip 126 to a rear of the mating contact 122. As discussed above, the mating contact portion 124 may be configured to receive the contact portion 114 to form an electrical connection between the contact 112 and the mating contact 122.

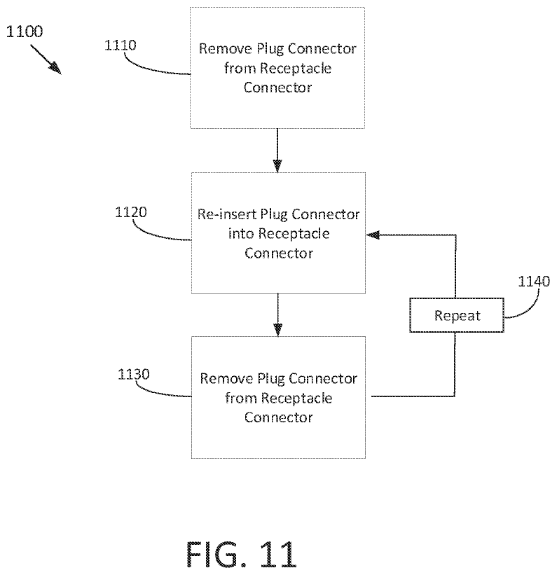

FIG. 11 is a flow chart illustrating an example method 1100 of utilizing an example electrical connector assembly. The method 1100, or one or more portions of the method 1100, may be performed using the example electrical connector assembly 100, and more particularly the first connector 110 and the second connector 120.

The method 1100 may include, at block 1110, removing a plug connector (e.g., second connector 120) from a receptacle connector (e.g., first connector 110) to decouple the plug connector from the receptacle connector. Because the plug connector and the receptacle connector form an electrical connection via their respective contacts, decoupling the connectors severs that electrical connection. As discussed above, the plug connector may include the first electrical contact 112, which itself may include the primary contact portion 114 and the protrusions 116. The receptacle connector may include the second electrical contact 122, which itself may include a mating contact portion 124. The electrical connection formed between the plug connector and the receptacle connector may be facilitated by electrical current flowing along the connection formed by the primary contact portion 114 and the mating contact portion 124. Electrical current may arc from the second electrical contact 122 to the last point of contact during decoupling, so electrical current may arc to the protrusion 116 rather than to the primary contact portion 114.

The method 1100 may also include, at block 1120, re-inserting the plug connector into the receptacle connector after the removal. Re-inserting the plug connector into the receptacle connector causes the connector to re-couple, as the first electrical contact 112 is again mated with the second electrical contact 122.

The method 1100 may further include, at block 1130, removing the plug connector from the receptacle connector after the plug connector was re-inserted. As described above with reference to block 1110, removing the plug connector from the receptacle connector decouples the connectors and severs the electrical connection between the two. Electrical current may again arc from the second electrical contact 122 to the last point of contact during decoupling, so, if there are two protrusions, electrical current may arc to the other protrusion than the protrusion to which electricity arced at block 1110.

The method 1100 may further include, at block 1140, repeating blocks 1120 and 1130 sequentially for a certain number of iterations. In some embodiments, the number of iterations may be based on a minimum number of disconnects (e.g., 250 disconnects) required by industry standard or other regulation. Due to possible damage from arcing, the number of iterations possible may be based on a length or amount that the protrusions 116 extend from the first electrical contact 112 (or second electrical contact 122). Known connectors may not be capable of such a large number of connects and disconnects while maintaining quality power transmission while connected, in particular in high-power applications.

An example embodiment for an electrical contact includes a primary contact portion configured to contact a mating electrical contact to form an electrical connection; and two or more protrusions extending from a forward portion of the electrical contact that is forward of the primary contact portion along a longitudinal direction, wherein the two or more protrusions are configured to receive external arcing from the mating electrical contact during a disconnect event.

In some embodiments, the two or more protrusions comprise a first protrusion and a second protrusion. The first protrusion and the second protrusion are laterally disposed on opposed lateral edges of the forward portion of the electrical contact on either side of the primary contact portion. In some of these embodiments, the first protrusion is substantially identical to the second protrusion.

In some embodiments, the two or more protrusions are configured to be a last point of contact between the electrical contact and the mating electrical contact during a disconnect event. In some embodiments, the primary contact portion is disposed on a forward-most portion of the electrical contact.

In some embodiments, a surface of each of the two or more protrusions is coplanar with a surface of the primary contact portion. In some embodiments, the two or more protrusions and the electrical contact are formed from a monolithic body of material.

In some embodiments, the electrical contact further includes a wire surface longitudinally provided at a rear portion of the contact and configured to receive an exposed end of a wire inserted into the contact. In some embodiments, the two or more protrusions are generally wedge-shaped.

An example embodiment of an electrical connector includes a connector housing; and an electrical contact configured to interact with a mating electrical contact of a mating electrical connector to form an electrical connection. The electrical contact includes a primary contact portion; and two or more protrusions extending from a forward portion of the electrical contact that is forward of the primary contact portion along a longitudinal direction. The two or more protrusions are configured to receive arcing from the mating electrical contact during a disconnect event.

In some embodiments, the electrical connector comprises a receptacle connector and the mating electrical connector comprises a plug connector. In some embodiments, the two or more protrusions comprise a first protrusion and a second protrusion, and wherein the first protrusion and the second protrusion are disposed on opposed lateral edges of the forward portion of the electrical contact on either side of the primary contact portion. In some of these embodiments, the first protrusion is substantially identical to the second protrusion.

In some embodiments, the two or more protrusions are configured to be a last point of contact between the electrical contact and the mating electrical contact during a disconnect event. In some embodiments, the two or more protrusions are recessed within the connector housing.

In some embodiments, the two or more protrusions and the electrical contact are formed from a monolithic body of material. In some embodiments, the connector housing comprises glass fibers.

An example embodiment of a method includes removing a plug connector from a receptacle connector to which the plug connector is electrically coupled. The removing electrically decouples the plug connector from the receptacle connector. The receptacle connector includes a primary contact portion configured to contact a mating electrical contact to form an electrical connection; and two or more protrusions extending from a forward portion of the electrical contact that is forward of the primary contact portion along a direction of the removing, and the plug connector comprises the mating electrical contact. The two or more protrusions are a last point of contact between the electrical contact and the mating electrical contact and are configured to receive external arcing from the mating electrical contact during the removing.

In some embodiments, electricity is conducted through the electrical connection during the removing. In some embodiments, the method further includes (a) after the removing, re-inserting the plug connector into the receptacle connector to electrically couple the plug connector with the receptacle connector; (b) removing the plug connector from the receptacle connector, after the re-inserting, to electrically decouple the plug connector from the receptacle connector; and (c) repeating (a) and (b) 250 or more times.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed is:

1. An electrical contact comprising:
a primary contact portion configured to contact a mating electrical contact to form an electrical connection; and
two or more protrusions extending from a forward portion of the electrical contact that is forward of the primary contact portion along a longitudinal direction,
wherein the two or more protrusions are configured to receive external arcing from the mating electrical contact during a disconnect event.

2. The electrical contact of claim 1, wherein the two or more protrusions comprise a first protrusion and a second protrusion, and wherein the first protrusion and the second protrusion are laterally disposed on opposed lateral edges of the forward portion of the electrical contact on either side of the primary contact portion.

3. The electrical contact of claim 2, wherein the first protrusion is substantially identical to the second protrusion.

4. The electrical contact of claim 1, wherein the two or more protrusions are configured to be a last point of contact between the electrical contact and the mating electrical contact during a disconnect event.

5. The electrical contact of claim 1, wherein the primary contact portion is disposed on a forward-most portion of the electrical contact.

6. The electrical contact of claim 1, wherein a surface of each of the two or more protrusions is coplanar with a surface of the primary contact portion.

7. The electrical contact of claim 1, wherein the two or more protrusions and the electrical contact are formed from a monolithic body of material.

8. The electrical contact of claim 1, further comprising a wire surface longitudinally provided at a rear portion of the contact and configured to receive an exposed end of a wire inserted into the contact.

9. The electrical contact of claim 1, wherein the two or more protrusions are generally wedge-shaped.

10. An electrical connector comprising:
a connector housing; and
an electrical contact configured to interact with a mating electrical contact of a mating electrical connector to form an electrical connection, the electrical contact comprising:
a primary contact portion; and
two or more protrusions extending from a forward portion of the electrical contact that is forward of the primary contact portion along a longitudinal direction,
wherein the two or more protrusions are configured to receive arcing from the mating electrical contact during a disconnect event.

11. The electrical connector of claim 10, wherein the electrical connector comprises a receptacle connector and the mating electrical connector comprises a plug connector.

12. The electrical connector of claim 10, wherein the two or more protrusions comprise a first protrusion and a second protrusion, and wherein the first protrusion and the second protrusion are disposed on opposed lateral edges of the forward portion of the electrical contact on either side of the primary contact portion.

13. The electrical connector of claim 12, wherein the first protrusion is substantially identical to the second protrusion.

14. The electrical connector of claim 10, wherein the two or more protrusions are configured to be a last point of contact between the electrical contact and the mating electrical contact during a disconnect event.

15. The electrical connector of claim 10, wherein the two or more protrusions are recessed within the connector housing.

16. The electrical connector of claim 10, wherein the two or more protrusions and the electrical contact are formed from a monolithic body of material.

17. The electrical connector of claim 10, wherein the housing comprises glass fibers.

18. A method comprising:
removing a plug connector from a receptacle connector to which the plug connector is electrically coupled, wherein:
the removing electrically decouples the plug connector from the receptacle connector,
the receptacle connector comprises an electrical contact that comprises:
a primary contact portion configured to contact a mating electrical contact to form an electrical connection; and
two or more protrusions extending from a forward portion of the electrical contact that is forward of the primary contact portion along a direction of the removing,
the plug connector comprises the mating electrical contact, and
the two or more protrusions are a last point of contact between the electrical contact and the mating electrical contact and are configured to receive external arcing from the mating electrical contact during the removing.

19. The method of claim 18, wherein electricity is conducted through the electrical connection during the removing.

20. The method of claim 18, further comprising:
(a) after the removing, re-inserting the plug connector into the receptacle connector to electrically couple the plug connector with the receptacle connector;
(b) removing the plug connector from the receptacle connector, after the re-inserting, to electrically decouple the plug connector from the receptacle connector; and
(c) repeating (a) and (b) 250 or more times.
